(19) United States
(12) Patent Application Publication
(10) Pub. No.: US 2019/0354684 A1
(43) Pub. Date: Nov. 21, 2019

(54) Secure Computing Systems and Methods

(71) Applicant: VM-Robot, Inc., Los Gatos, CA (US)

(72) Inventors: Alistair Black, Los Gatos, CA (US); Andrew Joseph DeBaets, Cupertino, CA (US)

(21) Appl. No.: 16/415,869

(22) Filed: May 17, 2019

Related U.S. Application Data
(60) Provisional application No. 62/672,946, filed on May 17, 2018.

(51) Int. Cl. G06F 21/57; G06F 8/61

(52) U.S. Cl. CPC G06F 21/572; G06F 2221/034; G06F 8/63

(57) ABSTRACT

A secure computing system is disclosed. The system may include a secure computing element. The secure computing element may include memory storing a first system image and a second system image. The system may also include a public computing element and a human input device may be embodied as hardware. The human input device may be configured such that selected actuations thereof transition the public computing element from running the first system image to running the second system image.

### RELATED APPLICATION

This application claims the benefit of co-pending U.S. Provisional Patent Application Ser. No. 62/672,946 filed May 17, 2018, which is hereby incorporated by reference.

### BACKGROUND

### Field of the Invention

This invention relates to computing systems and more particularly to systems and methods for secure computing.

### BACKGROUND OF THE INVENTION

Browsing the web, receiving email, installing software, installing software updates, running applications, and the like may expose a computer to malware. The risk that such malware is present may render the computer unsuited for performing certain tasks requiring a secure computing environment. As a result, a computer that is used for browsing the web, receiving email, installing software, installing software updates, running applications, and the like cannot typically also be used for tasks requiring a secure computing environment. Accordingly, what is needed is a system that permits a computer to be used to perform both unsecure tasks as well as secure tasks.

### BRIEF DESCRIPTION OF THE DRAWINGS

In order that the advantages of the invention will be readily understood, a more particular description of the invention will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a schematic block diagram illustrating one embodiment of a system in accordance with the present invention;

FIG. 2 is a schematic diagram illustrating a possible arrangement of the system of FIG. 1;

FIG. 3 is a state diagram illustrating one embodiment of the functionality of a system in accordance with the present invention;

FIG. 4 is a schematic block diagram illustrating how software and a hash of the software may be received via independent channels so that the software can be authenticated in accordance with the present invention;

FIG. 5 is a schematic block diagram illustrating one embodiment of a secure computing element of a system in accordance with the present invention;

FIG. 6 is a schematic block diagram illustrating one embodiment of a public computing element of a system in accordance with the present invention;

FIG. 7 is a schematic block diagram illustrating a public processor running a first system image while a second system image is being overwritten using a reference system image in order to return the second system image to a clean condition in accordance with the present invention; and

FIG. 8 is a schematic block diagram illustrating a public processor running a second system image while a first system image is being overwritten using a reference system image in order to return the first system image to a clean condition in accordance with the present invention.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

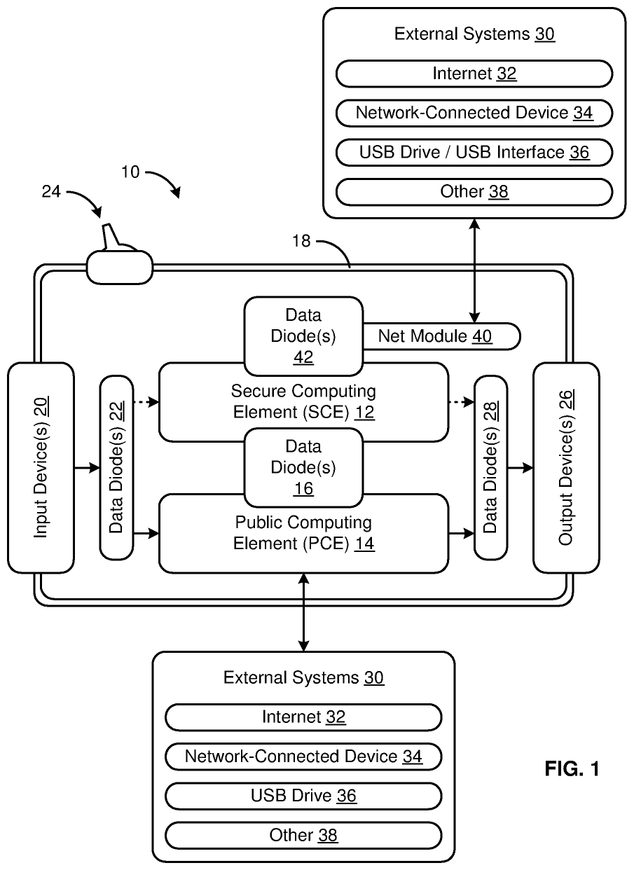

Referring to FIG. 1, computing and communication products (e.g., computers, laptops, mobile phones, tablets, and the like) exist in a highly networked and interconnected world. The connections may be wired (e.g., made using cables) or wireless (e.g., made using WIFI or cellular protocols and/or technologies). Typically the connections and the protocols that run through them are bidirectional. When the computing and communication products are connected to an interconnected and networked world, the security of the data on the devices, and communication to and from the products is subject to compromise or hacking. Compute cycles may also be stolen and used for purposes that the owners do not support. A computer system 10 in accordance with the present invention utilizes novel structures and methods to create or form a computing and communication product that can operate securely in a networked environment. Limiting and managing bidirectional communication may be one of the approaches utilized by a system 10.

In certain embodiments, a system 10 in accordance with the present invention may support multiple modes of operation and enable a human user to selectively transition between the modes. Accordingly, in one or more normal modes, a user may use the system 10 to browse the web, receive email, install software, install software updates, run application, and the like just as the user would using any other normal computer. Additionally, in one or more secure modes or secure states, a user may confidently and securely encrypt one or more documents, store or access sensitive data, or perform other tasks that require a secure computing environment.

To provide such functionality, a system 10 in accordance with the present invention may include a secure computing element (SCE) 12 and one or more public computing elements (PCE) 14. An SCE 12 may be or provide a secure computing environment in which certain tasks requiring such an environment may be performed. A PCE 14 may be or provide a normal computing environment that may, through normal browsing the web, receiving email, installing software, installing software updates, running applications, or the like, inadvertently be contaminated with malware (e.g., computer viruses, ransomware, spyware, worms, Trojan horses, adware, scareware, rootkits, bootkits, keyloggers, screen scrapers, backdoors, logic bombs, or the like or any other software designed to damage a computer or computer network, facilitate stealing from, spying on, or otherwise harming human users of a computer or computer network, or the like).

Within a system 10, an SCE 12 and a PCE 14 may be interconnected via one or more data diodes 16. A data diode 16 (sometimes also referred to as an information diode) may be or include hardware that physically enforces a one-way flow of data. This physical limitation on the flow of data may isolate and protect an SCE 12 from any malware contaminating the computing environment of a PCE 14. Accordingly, one or more data diodes 16 may enable an SCE 12 to interact with a PCE 14 without the risk of being contaminated by such interaction. Certain systems and methods involving one or more data diodes are disclosed in U.S. patent application Ser. No. 15/603,232 filed May 23, 2017 (the '232 application), which is hereby incorporated by reference. In selected embodiments, systems and methods disclosed within the '232 application may be employed in systems 10 in accordance with the present invention wherever they would fit, work, or be advantageous.

In selected embodiments, one or more data diodes 16 (as well as one or more other data diodes forming part of a system 10 in accordance with the present invention) may be switched data diodes. Switched data diodes may be turned on and off (e.g., enabled and disabled). In selected embodiments, a switched data diode may be constructed using, for example, a gated simplex bus. A gated simplex bus may be a simplex bus that can be disabled and enabled. This may be done in a number of ways including gating each signal with a logic function (e.g., AND, OR) or putting outputs driving the simplex bus into a high impedance (i.e., a “tri-state”) condition. Such a bus may comprise one or more connections between a source and a destination.

In certain embodiments, an SCE 12 and a PCE 14 may reside on a single printed circuit board. Accordingly, a single printed circuit board may include a CPU socket for a processor corresponding to an SCE 12, a CPU socket for a processor corresponding to a PCE 14, memory or one or more locations for connecting memory, various components and communication pathways as needed, and the like in order to support proper operation of an SCE 12 and a PCE 14. In certain embodiments, the functionality of a system 10 (e.g., the functionality of an SCE 12, PCE 14, etc.) may be integrated onto the same chip or substrate. This may be done with an ASIC or FPGA, either of which may include, support, or connect multiple microprocessors. Accordingly, a system 10 may be configured as a System on a Chip (SOC), a Programmable System on a Chip (PSOC), or the like. In still other embodiments, an SCE 12 and a PCE 14 may reside on separate printed circuit boards that are connected via sockets, cables, or the like.

In selected embodiments, an SCE 12 and a PCE 14 may be housed within or on a single computer chassis 18. A computer chassis 18 may be a structure to which various components of a system 10 may be secured or fixed. For example, a computer chassis 18 may be a frame or housing to which one or more printed circuit boards corresponding to an SCE 12 and/or a PCE 14 may be fixed (e.g., screwed, bolted, snapped, or otherwise secured in place). A computer chassis 18 may be or comprise a vertical tower housing, a flat desktop housing, a rack-mountable housing, a blade structure configured for incorporation within a blade enclosure, a laptop housing, a tablet housing, or the like. Alternatively, a computer chassis 18 may simply be a board (e.g., a printed circuit board) that physically connects and supports various components forming a system 10 in accordance with the present invention. Accordingly, to a large degree, a user may experience the exterior look and feel of a system 10 in accordance with the present invention just as he or she would a conventional desktop computer, rack-mounted system, blade server, laptop computer, tablet, or the like.

In certain embodiments, a system 10 may include one or more input devices 20. An input device 20 may enable a user to input or communicate one or more commands, data, or the like to a system 10. Suitable input devices 20 may include one or more pointing devices (e.g., a mouse, trackpad, or the like), buttons, switches, keys, keyboards, touch screens, microphones, cameras, security modules/fobs such as those marketed under the YUBIKEY trademark, or the like or a combination or sub-combination thereof. One or more input devices 20 may be located exterior to a chassis 18. Alternatively, or in addition thereto, one or more input devices 20 may form part of or be fixed to a chassis 18. For example, if a chassis 18 comprises a laptop housing, one or more input devices 20 in the form of buttons, switches, a keyboard, trackpad, or the like may form part of or be fixed to the chassis 18. Similarly, if a chassis 18 comprises a tablet housing, an input device 20 in the form of a touch screen may form part of or be fixed to the chassis 18.

In selected embodiments, one or more data diodes 22 may connect one or more input devices 20 to an SCE 12 or a PCE 14. Accordingly, commands input by a user through one or more input devices 20 may be passed via one or more data diodes 22 to an SCE 12 or a PCE 14. In certain embodiments, a switch 24 (e.g., a piece of hardware mounted to a chassis 18) may determine whether commands input by a user through one or more input devices 20 are passed to an SCE 12 or to a PCE 14. Accordingly, a user may select whether to do work directed on an SCE 12 or a PCE 14.

In certain embodiments, a system 10 may include one or more output devices 26. An output device 26 may enable a system 10 to output data or otherwise present information to a user. Suitable output devices 26 may include one or more lights, speakers, screens, displays, or the like or a combination or sub-combination thereof. One or more output devices 26 may be located exterior to a chassis 18. Alternatively, or in addition thereto, one or more output devices 26 may form part of or be fixed to a chassis 18. For example, if a chassis 18 comprises a laptop housing, one or more output devices 26 in the form of lights and/or a screen may form part of or be fixed to the chassis 18. Similarly, if a chassis 18 comprises a tablet housing, an output device 26 in the form of a touch screen may form part of or be fixed to the chassis 18.

In selected embodiments, one or more data diodes 28 may connect one or more output devices 26 to an SCE 12 or a PCE 14. Accordingly, data or other information output by an SCE 12 or a PCE 14 may be presented or otherwise communicated to a user. In certain embodiments, a switch 24 may determine whether an SCE 12 or a PCE 14 is connected to one or more output devices 26. Accordingly, by actuating a switch 24, a user may toggle one or more input devices 20 and output devices 26 from an SCE 12 to or a PCE 14 or vice versa.

For example, when a switch 24 is in a first position, the switch 24 may connect one or more input devices 20 and one or more output devices 26 to an SCE 12. Conversely, when the switch 24 is in a second position, the input and output devices 20, 26 may be connected to a PCE 14. In certain embodiments, other arrangements of input and output devices 20, 26 (e.g., arrangements where one or more input devices 20 are connected to an SCE 12 and one or more output devices 26 are connected to PCE 14), may be prohibited.

In certain embodiments and in certain modes of operation, a PCE 14 may interact with one or more external systems 30. Such external systems 30 may include the Internet 32, one or more network-connected devices 34, one more USB drives 36 or other external storage devices, other systems 38 or the like or a combination or sub-combination thereof. Accordingly, a user may use a PCE 14 to browse the web, receive email, install software, install software updates, run applications, and the like just as the user would using any other normal computer.

In selected embodiments and in certain modes of operation, an SCE 12 may also interact with one or more external systems 30. However, an SCE 12 may not interact directly with external systems 30. That is, in certain embodiments, a system 10 may include a network module 40. A network module 40 and an SCE 12 may be interconnected via one or more data diodes 42. This physical limitation on the flow of data alone or in combination with certain security procedures may isolate and protect an SCE 12 from any malware present on the external systems 30. Accordingly, an SCE 12 may interact with one or more external systems 30 without the risk of being contaminated by such interaction.

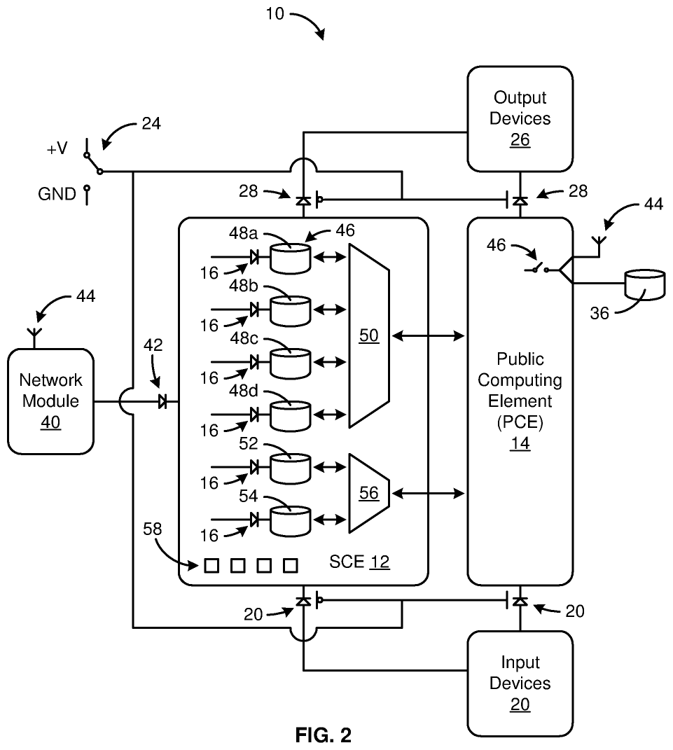

Referring to FIG. 2, in selected embodiments, a PCE 14 and a network module 40 may each include an antenna 44. An antenna 44 may enable a PCE 14 and/or a network module 40 to interact wirelessly with one or more external systems 30. Alternatively, or in addition thereto, network module 40 may include connectors for a direct wired attachment to a computer network. In certain embodiments, a switch 46 may be located between an antenna 44 and the rest of a corresponding PCE 14. When the switch 46 is closed, the antenna 44 may be ready for use. When the switch 46 is open, the PCE 14 may be cut off from any wireless interaction with an external system 30.

In certain embodiments, a switch 46 in an open condition may also disconnect all other external systems 30 (e.g., USB drives 36, other network connections, or the like) from a PCE 14. For example, when a switch 46 is closed, a PCE 14 may interact with any available or connected external systems 30 in a normal manner. However, when a switch 46 is open, a PCE 14 may be cut off from all interaction with all external systems 30.

A switch 46 may be a mechanical device. Due to its mechanical nature, a switch 46 may not be controlled by software. This may prevent malware attacks where the controlling software of an electronic switch is hacked and the switch and corresponding system is controlled from a distance by an attacker.

An SCE 12 may store multiple system images 48. A system image 48 may be a computer file replicating the contents and structure of a disk or other storage device. In selected embodiments, a system image 48 may include operating system (OS) files, application files corresponding to one or more software applications, user account settings, user files (e.g., files created by a user of a system 10), and the like or a combination or sub-combination thereof. A system image 48 may be configured so as to be run by a PCE 14. A PCE 14 may treat a system image 48 as if it were a hard drive, solid state drive, or the like providing the storage system of the PCE 14.

In selected embodiments, one particular system image 48a stored within an SCE 12 may be an original system image 48a. An original system image 48a may be, in effect, the original storage system of a PCE 14. Accordingly, an original system image 48a may contain the operating system (OS) files, application files, user account settings, user files, etc. as they currently stand, including whatever changes have been made thereto since some beginning date (typically the date the particular instance of the system 10 was first put into service by the user). Thus, an original system image 48a may resemble the storage system of a typical computer that has been in normal use for some period of time.

In selected embodiments, one particular system image 48b stored within an SCE 12 may be a first clean system image 48b. A first clean system image 48b may contain a clean, up-to-date install of the operating system (OS) files and a clean, up-to-date install of the application files. In certain embodiments, a first clean system image 48b may not contain any user files. Accordingly, a first clean system image 48b may resemble the storage system of a typical computer that is just being put into service and has not been worked with and/or exposed to any external systems 30.

In selected embodiments, one particular system image 48c stored within an SCE 12 may be a second clean system image 48c. Just like a first clean system image 48b, a second clean system image 48c may contain a clean, up-to-date install of the operating system (OS) files and a clean, up-to-date install of the application files. Also, in certain embodiments, a second clean system image 48c may not contain any user files. If a first clean system image 48b is characterized as “ping,” a second clean system image 48c may be characterized as “pong.” In selected embodiments, this characterization may reflect the alternating nature in which the first and second clean system images 48b, 48c are used in certain methods in accordance with the present invention.

In certain embodiments, one particular system image 48d stored within an SCE 12 may be a reference system image 48d. A reference system image 48d may contain a clean, up-to-date install of the operating system (OS) files and a clean, up-to-date install of the application files. In certain embodiments, a reference system image 48d may not contain any user files. Accordingly, a reference system image 48d may resemble the storage system of a typical computer that is just being put into service and has not been worked with and/or exposed to any external systems 30. In selected embodiments, a reference system image 48d may be employed to write over a first or second clean system image 48b, 48c that has been used in order to return it to a “clean” configuration.

While a system 10 in accordance with the present invention may have four system images 48 as described above, other embodiments of a system 10 may include a different number of system images 48. For example, in certain embodiments, as few as two system images 48 may be used (e.g., a first clean system image 48b and a reference system image 48d). In other embodiments, more than four system images 48 may be used.

In certain embodiments, an SCE 12 may include a first multiplexer 50. A first multiplexer 50 may control which system image 48 is accessible or delivered to a PCE 14. A first multiplexer 50 may ensure that no more than one system image 48 is accessible or delivered to a PCE 14 at any given moment in time. Accordingly, a first multiplexer 50 may control which version of storage system is run by a PCE 14 at any given moment in time.

In selected embodiments, an SCE 12 may store one or more authenticated files 52. An authenticated file 52 may be a file that (1) is obtained by an SCE 12 through a secure on-boarding/updating process and (2) has been authenticated by the SCE 12. Accordingly, an authenticated file 52 may be ready to be installed by a PCE 14, SCE 14, or some combination thereof into a desired system image 48. When so installed, an authenticated file 52 may bring an operating system, application, or the like corresponding to the system image 48 up to date.

In certain embodiments, an SCE 12 may store one or more user files 54. A user file 54 may be a file created by a user within an SCE 12 while selected human I/O devices 20, 26 are connected to the SCE 12. A user file 54 may also be created using a PCE 14 when the overall system 10 is in a secure state or secure mode.

For example, a user may wish to send an email with an encrypted document attached thereto. For security reasons, an SCE 12 may not be connected to external systems 30 in a manner supporting email communication. Moreover, for security reasons, a PCE 14 may be an improper location to create an encrypted file. Accordingly, a user may (1) switch the human I/O devices 20, 26 to an SCE 12, (2) create an encrypted document within that secure environment, and then (2) push the document through one or more data diodes to a storage element (e.g., a storage element corresponding to or configured to contain user files 54). Later, the user may switch the human I/O devices 20, 26 to a PCE 14, read the encrypted file from the storage element, and send the encrypted document as an email attachment. In such a process, a PCE 14 and the external systems 30 connected thereto may only ever see or experience the attachment as an already encrypted document and may be powerless to decrypt it. Alternatively, or in addition thereto, a user may (1) switch the human I/O devices 20, 26 to a PCE 14, (2) transition the PCE 14 into a secure state or secure mode, (3) create a document, and (4) store that document on a storage element forming part of an SCE 12 (e.g., a storage element corresponding to or configured to contain user files 54).

In certain embodiments, an SCE 12 may include a second multiplexer 56. A second multiplexer 56 may control which files 52, 54 are accessible or delivered to a PCE 14. Accordingly, a second multiplexer 56 may control which files stored on an SCE 12 may be accessed by a PCE 14 at any given moment in time.

In selected embodiments, a system 10 in accordance with the present invention may include certain chassis-mounted input mechanism 58 that are or form hardware-based switches, hardware-based buttons, or the like. Actuation of one or more of these input mechanisms 58 may control novel features of a system 10, including how the system 10 operates, the mode of the system 10, or the like. Due to their manual, mechanical nature, these input mechanisms 58 may not be controlled (e.g., actuated) by software. This may prevent malware attacks where the controlling software of an electronic switch is hacked and the switch and corresponding system is remotely controlled by an attacker. Accordingly, input mechanisms 58 may be differentiated from conventional input devices 20 that are commonly used to communicate commands or information to a computer.

In certain embodiments, one particular input mechanism 58 may be a “New PC” momentary contact switch that causes, when actuated, a PCE 14 to start running a clean system image 48 (e.g., either a first clean system image 48b or a second clean system image 48c). Another particular input mechanism 58 may be an “Original PC” momentary contact switch that causes, when actuated, a PCE 14 to start running (or return to running) an original system image 48a.

Another particular input mechanism 58 may be a “Secure/Normal” switch (e.g., a single pole double throw switch) that may toggle between a secure mode of operation and a normal mode of operation. In selected embodiments, cutting off a PCE 14 from all external systems 30 may be one requirement of a secure mode. Accordingly, a switch 46 controlling access to such external systems 30 may be or be controlled by an input mechanism 58 that is configured as a “Secure/Normal” switch.

Another particular input mechanism 58 may be a “Human I/O” switch that may control whether the input and output devices 20, 26 are connected to an SCE 12 or to a PCE 14. Accordingly, a switch 24 controlling the connectivity of such devices 20, 26 may be or be controlled by an input mechanism 58 that is configured as a “Human I/O” switch.

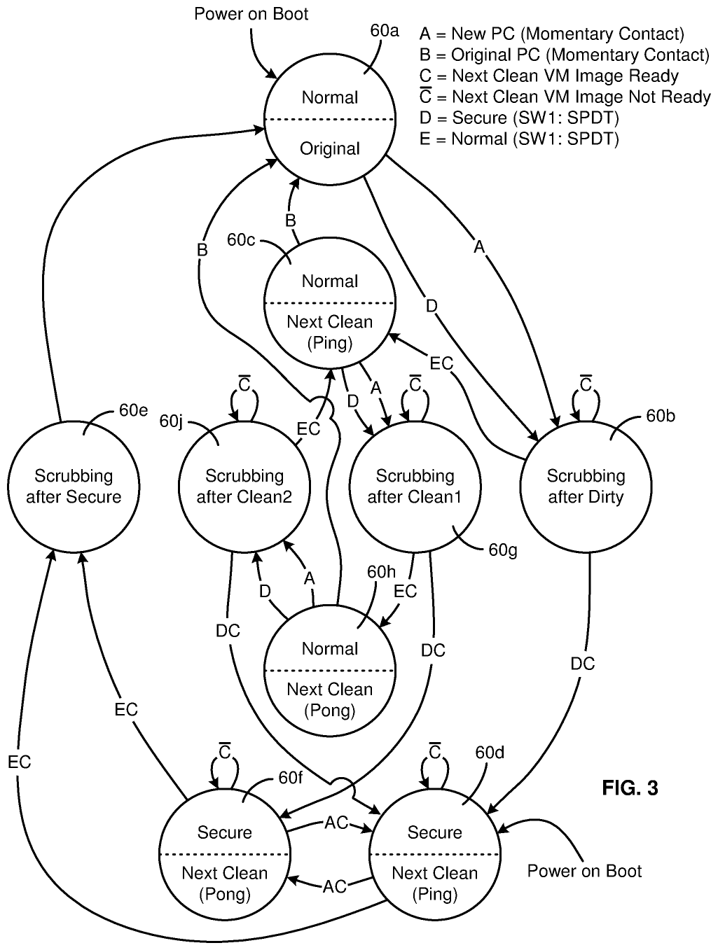

Referring to FIG. 3, depending on which input mechanisms 58 are in which locations when other input mechanisms 58 are actuated, a PCE 14 of system 10 in accordance with the present invention may transition between various states 60. In selected embodiments, if a “Secure/Normal” input mechanism 58 is set to normal mode, a power on boot may bring a PCE 14 up in a first normal state 60a.

A first normal state 60a may correspond to a normal mode of operation with a PCE 14 running an original system image 48a. Because an original system image 48a may contain the operating system (OS) files, application files, user account settings, user files, etc. as they currently stand, including whatever changes have been made thereto since some beginning date, a first normal state 60a may be considered a “dirty” state. That is, first normal state 60a may be a state 60 in which the storage system of the PCE 14 is contaminated with malware or could be contaminated with malware sometime in the future and is, therefore, presumed to have malware present.

When in a first normal state 60a, a user may have two options including (1) actuating a “New PC” input mechanism 58 or (2) actuating a “Secure/Normal” input mechanism 58 to toggle out of normal mode and into secure mode. Both these options may transition a PCE 14 to a first scrubbing state 60b (i.e., a “scrubbing after dirty” state 60b).

A first scrubbing state 60b may correspond to or initiate certain steps that enable a PCE 14 to properly move to a desired next state 60. In selected embodiments, such steps may include one or more of: (1) taking a snapshot of a current state of the original system image 48a, thereby giving a PCE 14 a proper, up to date original system image 48a to come back to whenever a user actuates an “Original” input mechanism 58 (in certain alternative embodiments, this step may comprise placing an operating system image into “sleep” mode where the software and the hardware state are saved on the storage system for a rapid restart in the future); (2) disconnecting a PCE 14 from all system images 48; (3) breaking any connection of the PCE 14 to an antenna 44 or external system 30 (a cut of power effecting this break may be provided independent of the rest of a subsystem forming the PCE 14); (4) removing power from the remainder of the PCE 14 and discharging all storage elements; (5) waiting a period of time required for a board forming the PCE 14 to fully discharge; (6) restoring power to the PCE 14 while keeping all power off with respect to the antenna 44 and all external systems 30; and (7) performing a JTAG scan of all chips corresponding to the PCE 14 to verify manufacturing power on state.

Manufacturing power on state at a chip level may refer to the state of a chip just off of the chip manufacturing process after power has been applied, the reset signal has been asserted, and the chip has completed its state transitions to complete the reset process. A chip in this state may be ready for a functional test to verify that no manufacturing defects are present in the chip. After a successful completion of such a functional test, which test may be performed through a JTAG interface, the chip may be in its manufacturing power on state. A computer assembly on a printed circuit board may have several such chips. Accordingly, to bring a PCE 14 into manufacturing power on state, all chips with embedded microprocessors or non-volatile storage may each be brought into their respective manufacturing power on state.

Obtaining a “New PC” and entering secure mode both require use of a clean system image 48b, 48c. Accordingly, a clean system image 48b, 48c must be ready to use before the full effect of actuating a “New PC” input mechanism 58 or toggling a “Secure/Normal” input mechanism 58 into secure mode can be realized. When a next state 60 requires a clean system image 48b, 48c and no clean system image 48b, 48c is ready, a PCE 14 may stay in a current state 60. For example, if, after completing the steps corresponding to a first scrubbing state 60b, a clean system image 48b, 48c is not ready, a PCE 14 may stay in the first scrubbing state 60b. Only when a clean system image 48b, 48c is ready may a PCE 14 move on to a next state 60 that requires a clean system image 48b, 48c.

If a “New PC” input mechanism 58 was actuated while in a first normal state 60a, the steps of a first scrubbing state 60b have been completed, and a clean system image 48b is ready, then a PCE 14 may advance to a second normal state 60c. This may entail connecting a first clean system image 48b (“ping”) to the PCE 14 and enabling connection to one or more external systems 30 (e.g., the Internet 32). This second normal state 60c may ensure that no malware is present at the start of the working session. However, due to the fact that the PCE 14 is connected or can be connected to external systems 30, contamination with malware may occur during the working session.

A user may choose to operate in a second normal state 60c when the user needs to interact with external systems 30 and would like to do so as securely as possible. For example, a user may wish to conduct online banking, while ensuring that no previous contaminations of malware can track or spy on that activity.

If a “Secure/Normal” input mechanism 58 was, while in a first normal state 60a, toggled into secure mode, the steps of a first scrubbing state 60b have been completed, and a clean system image 48b is ready, then a PCE 14 may advance to a first secure state 60d. This may entail connecting a ping image 48b to the PCE 14 and maintaining disabled all connections to one or more external systems 30. This may be done while keeping a switch 46 in an open position. In certain embodiments, such a switch 46 may be an electronic switch under direct control of a “Secure/Normal” switch that is a mechanical switch (e.g., an input mechanism 58 requiring manual actuation). This first secure state 60d may ensure that no malware is present at the start of the working session. It may also ensure that no malware is introduced during the working session. Accordingly, a user may choose to operate in a first secure state 60d when the user needs to perform tasks that require a secure computing environment.

When in a first secure state 60d, a user may have two options including (1) actuating a “New PC” input mechanism 58 or (2) actuating a “Secure/Normal” input mechanism 58 to toggle out of secure mode and into normal mode. The latter option may transition a PCE 14 to a second scrubbing state 60e (i.e., a “scrubbing after secure” state 60e). The former option may, if a second clean system image 48b (“pong”) is ready, simply transfer a PCE 14 to a second secure state 60f A second secure state 60f may correspond to a pong image 48b being connected to a PCE 14, while maintaining disabled all connections to one or more external systems 30. Thus, a transition from a first secure state 60d to a second secure state 60f may exist due to an always-available nature a “New PC” input mechanism 58, but it may typically not provide any advantage to effect such a transition.

A second scrubbing state 60e may correspond to or initiate certain steps that enable a PCE 14 to properly move to a desired next state 60. In selected embodiments, such steps may be those corresponding to a first scrubbing state 60b, but may not include taking a snapshot of a current state of any image 48. That is, when leaving a first secure state 60d (or a second secure state 60f), there may be no need to give a PCE 14 a worked-in ping (or pong) image 48a to come back to when a user actuates a “New PC” input mechanism 58.

Once one or more steps associated with a second scrubbing state 60e have been completed, a PCE 14 may be transitioned to the first normal state 60a. This may entail connecting the original system image 48a to the PCE 14 and enabling connection to one or more external systems 30. In selected embodiments, the original system image 48a to which a PCE 14 is connected may correspond to or be a snapshot of the original system image 48a taken the last time the PCE 14 transitioned away from the original system image 48a. Accordingly, a user returning to his or her activities within the original system image 48a may find things just as he or she left them. This may be true regardless of the state 60 a PCE 14 leaves on its return to the first normal state 60a.

Alternatively, once one or more steps associated with a second scrubbing state 60e have been completed, a PCE 14 may be transitioned to back to a normal state 60 that was last occupied by the PCE 14. For example, a PCE 14 may return to a first state 60a if that was the last normal state 60 occupied before transitioning to secure mode. Alternatively, a PCE 14 may return to a second normal state 60c or a third normal state 60h if the last state occupied was the second normal state 60c or the third normal state 60h, respectively.

When in a second secure state 60f, a user may have two options including (1) actuating a “New PC” input mechanism 58 or (2) actuating a “Secure/Normal” input mechanism 58 to toggle out of secure mode and into normal mode. The latter option may transition a PCE 14 to the second scrubbing state 60e. The former option may, if a ping image 48b is ready, simply transfer a PCE 14 to a first secure state 60d. Transitioning from a second secure state 60f to a first secure state 60e may exist due to an always-available nature a “New PC” input mechanism 58, but it may typically not provide any advantage to effect such a transition.

When in a second normal state 60c, a user may have three options including (1) actuating a “New PC” input mechanism 58, (2) actuating a “Secure/Normal” input mechanism 58 to toggle out of normal mode and into secure mode, and (3) actuating an “Original” input mechanism 58. The third option may entail connecting the original system image 48a to the PCE 14 (no change may need to be made to connections with one or more external systems 30 as they are enabled in both states 60c, 60a). The first two options may transition a PCE 14 to a third scrubbing state 60g (i.e., a “scrubbing after clean1” state 60g).

A third scrubbing state 60g may correspond to or initiate certain steps that enable a PCE 14 to properly move to a desired next state 60. In selected embodiments, such steps may be those corresponding to a first scrubbing state 60b, but may not include taking a snapshot of a current state of any image 48. That is, when leaving a second normal state 60c, there may be no need to give a PCE 14 a worked-in ping image 48b to come back to when a user actuates a “New PC” input mechanism 58.

If a “New PC” input mechanism 58 was actuated while in a second normal state 60c, the steps of a third scrubbing state 60g have been completed, and a clean system image 48c is ready, then a PCE 14 may advance to a third normal state 60h. This may entail connecting a pong image 48c to the PCE 14 and enabling connection to one or more external systems 30. This third normal state 60h may ensure that no malware is present at the start of the working session. However, due to the fact that the PCE 14 is connected or can be connected to external systems 30, contamination with malware may occur during the working session.

A user may choose to operate in a third normal state 60h when the user needs to interact with external systems 30 and would like a fresh start to do so as securely as possible. For example, a user may wish to conduct online banking with multiple banks. Online banking may be conducted with a first bank in a second normal state 60c, while online banking may be conducted with a second bank in a third normal state 60h. In this manner, no contamination occurring while working in the second normal state 60c will be able to adversely affect work in the third normal state 60h.

If a “Secure/Normal” input mechanism 58 was, while in a second normal state 60c, toggled into secure mode, the steps of a third scrubbing state 60g have been completed, and a clean system image 48c is ready, then a PCE 14 may advance to a second secure state 60f. This may entail connecting a pong image 48c to the PCE 14 and maintaining disabled all connections to one or more external systems 30.

When in a third normal state 60h, a user may have three options including (1) actuating a “New PC” input mechanism 58, (2) actuating a “Secure/Normal” input mechanism 58 to toggle out of normal mode and into secure mode, and (3) actuating an “Original” input mechanism 58. The third option may entail connecting the original system image 48a to the PCE 14 (no change may need to be made to connections with one or more external systems 30 as they are enabled in both states 60h, 60a). The first two options may transition a PCE 14 to a fourth scrubbing state 60j (i.e., a “scrubbing after clean2” state 60j).

A fourth scrubbing state 60j may correspond to or initiate certain steps that enable a PCE 14 to properly move to a desired next state 60. In selected embodiments, such steps may be those corresponding to a first scrubbing state 60b, but may not include taking a snapshot of a current state of any image 48. That is, when leaving a third normal state 60h, there may be no need to give a PCE 14 a worked-in pong image 48c to come back to when a user actuates a “New PC” input mechanism 58.

If a “New PC” input mechanism 58 was actuated while in a third normal state 60h, the steps of a fourth scrubbing state 60j have been completed, and a clean system image 48b is ready, then a PCE 14 may advance to the second normal state 60c. This may entail connecting a ping image 48b to the PCE 14 and enabling connection to one or more external systems 30.

If a “Secure/Normal” input mechanism 58 was, while in a third normal state 60h, toggled into secure mode, the steps of a fourth scrubbing state 60j have been completed, and a clean system image 48b is ready, then a PCE 14 may advance to a first secure state 60d. This may entail connecting a ping image 48b to the PCE 14 and maintaining disabled all connections to one or more external systems 30.

In selected embodiments, if a “Secure/Normal” input mechanism 58 is set to secure mode, a power on boot may bring a PCE 14 up in a first secure state 60d. In certain embodiments, all cases of power on boot may pass a PCE 14 through a first scrubbing state 60b and/or the steps associated with that state as described above before the hardware power-on process is complete and the software boot process can begin.

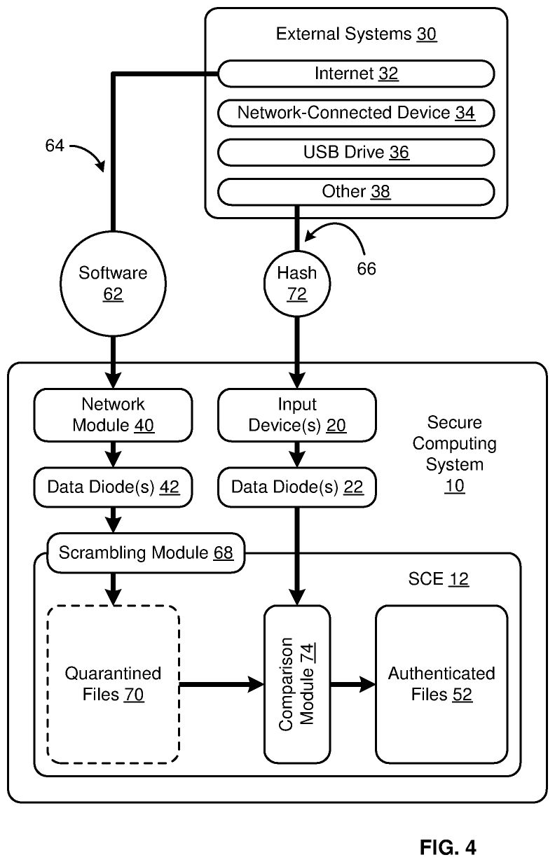

Referring to FIG. 4, a user working on a PCE 14 that is running an original system image 48a may be free to install whatever software 62 (e.g., new operating system, operating system updates, software applications, application updates, software add-ons or extensions, or the like) he or she may like. Moreover, whenever the user returns to the original system image 48a after working in a clean system image 48b, 48c, that software 62 may still be in place.

In certain embodiments however, any software 62 installed on a clean system image 48b, 48c may be over written once the corresponding working session is completed (e.g., once the user transitions a PCE 14 to a new clean system image 48b, 48c or returns it to an original system image 48a). Accordingly, in selected embodiments, a secure on-boarding/updating process 64 acting in conjunction with an authentication process 66 may make software 62 stored in a storage element (e.g., a storage element corresponding to or configured to contain an original system image 48a) available for install so the software 62 may be used in future clean system images 48b, 48c.

In certain embodiments, an authenticated file 52 may be software 62 or other incoming data that has passed through a secure on-boarding/updating process 64 and been authenticated by an authentication process 66. In selected embodiments, a first step of a secure on-boarding/updating process 64 may be determining what software 62 to download and when to do it. This first step may be performed manually or via an automated process. For example, a user may switch a human I/O to a PCE 14 and use a network module 40 connected to the SCE 12 via one or more data diodes 42 to download a particular piece of software 62. In certain embodiments, an update mode or process may require that an external, removable cable be installed in order for a PCE 14 to direct the operation of a network module 40.

In selected embodiments, software 62 (or other incoming data) may be downloaded into a network module 40 by the network module 40 itself. Thereafter, the network module 40 may push the software 62 through one or more data diodes 42. Optionally, the software 62 may be scrambled by a scrambling module 68 using a pseudo-random bitstream from an SCE 12. Accordingly, the location of a scrambling module 68 or the functions performed thereby may be interchanged with one or more data diodes 42, 22 or the functions thereof within a secure on-boarding/updating process 64, an authentication process 66, or both. Alternatively, a scrambling module 68 may also be included as part of a network module 40.

In a scrambling process corresponding to a scrambling module 68, software 62 entering an SC E 12 may be scrambled with a cryptographic sequence from the SCE 12. The software 62 may be descrambled after it is within a quarantined area within the SCE 12. Accordingly, a scrambling process may prevent the insertion of hostile software.

In selected embodiments, a scrambling module 68 may accept a pseudorandom bitstream from an SCE 12 and input data (e.g., software 62) from one or more data diodes 42 and add the bits together with an exclusive or logical operation. This may prevent electrical pattern attacks at the physical level when data or program files enter an SCE 12. This feature may also support secure communication between two systems 10 in accordance with the present invention (e.g., secure communication between a first system 10 in accordance with the present invention and a second system 10 in accordance with the present invention via a computer network as disclosed in U.S. Provisional Patent Application Ser. No. 62/672,946).

Once it is scrambled, software 62 or other incoming data may be stored within quarantined area of an SCE 12. For example, the software 62 may be stored within an SCE 12 as one or more quarantined files 70. Accordingly, in a secure on-boarding/updating process 64, software 62 may be unable to harm an SCE 12 as it enters the SCE 12 and it may be unable to harm the SCE 12 as it is stored within the SCE 12.

In selected embodiments, scrambling may be removed as part of an authentication process 66 to authenticate a quarantined file 66. A mechanism to transition from scrambled to the original software 62 may be to again add the pseudo random bitstream using the exclusive or logical operation. The bitstream may be added from the same starting points for both the incoming data (e.g., the software 62) and the incoming pseudo random bitstream.

Additionally, in an authentication process 66, a hash value 72 may be obtained by an SCE 12. That is, in certain embodiments, a supplier or source of certain software 62 may use a cryptographic hash function or algorithm to map the software 62 onto a hash value 72 of a fixed size. Accordingly, an SCE 12 may use such a hash value 72 to authenticate that software 62.

In selected embodiments, to increase security, an SCE 12 may obtain a hash value 72 via a channel that is independent of the channel by which the SCE 12 obtained the software 62 or incoming data corresponding to the hash value 72. For example, if an SCE 12 obtains certain software 62 via an Internet download, then an SCE 12 may obtain a hash value 72 corresponding to that software 62 via a physical mailer (e.g., a postcard or letter with a QR code or the like printed thereon), a text message received over a cellular network, an email message, a voice message (e.g., an automated telephone system where a user can call in to obtain certain most recent hashes), or the like.

In certain embodiments, a hash value 72 may be communicated by a user to an SCE 12 via one or more input devices 20. For example, a user may type a hash value 72 into an SCE 12 using a keyboard. Alternatively, a user may present a hash value 72 in the form of a QR code received via mail, email, or the like to a camera of a system 10. Thereafter, the hash value 72 may be pushed into an SCE 12 through one or more data diodes 22.

Quarantined files 70 may be software 62 or other incoming data stored in a quarantined area located within an SCE 12. Quarantined files 70 may be unscrambled by an SCE 12 in order to return the original software 62 in the quarantined area. The SCE 12 may calculate a hash value of the software 62 or other incoming data in the quarantine area using the same hash algorithm used to create the hash value 72 obtained from the source. This calculated hash value may be compared (e.g., by a comparison module 74) to the hash value 72 passed in through one or more input devices 20. If the comparison module 74 determines that the hash values match, the software 62 or other incoming data may be authenticated and moved into authenticated file storage (e.g., become one or more authenticated files 52). From authenticated file storage, the software 62 may be safely used by or within an SCE 12 as desired or necessary. If the comparison module 74 determines that the hash values do not match, the software 62 or other incoming data may be discarded.

In selected embodiments, one or more authenticated files 52 may be installed within a desired system image 48. For example, in an update process, one or more authenticated files 52 may be installed within a reference system image 48d by a PCE 14, an SCE 12, or a PCE 14 acting in cooperation with an SCE 12. Alternatively, one or more authenticated files 52 may be installed within a first or second clean system image 48b, 48c by a PCE 14, an SCE 12, or a PCE 14 acting in cooperation with an SCE 12. Thereafter, the first or second clean system image 48b, 48c in updated form may be used to over write a reference system image 48d.

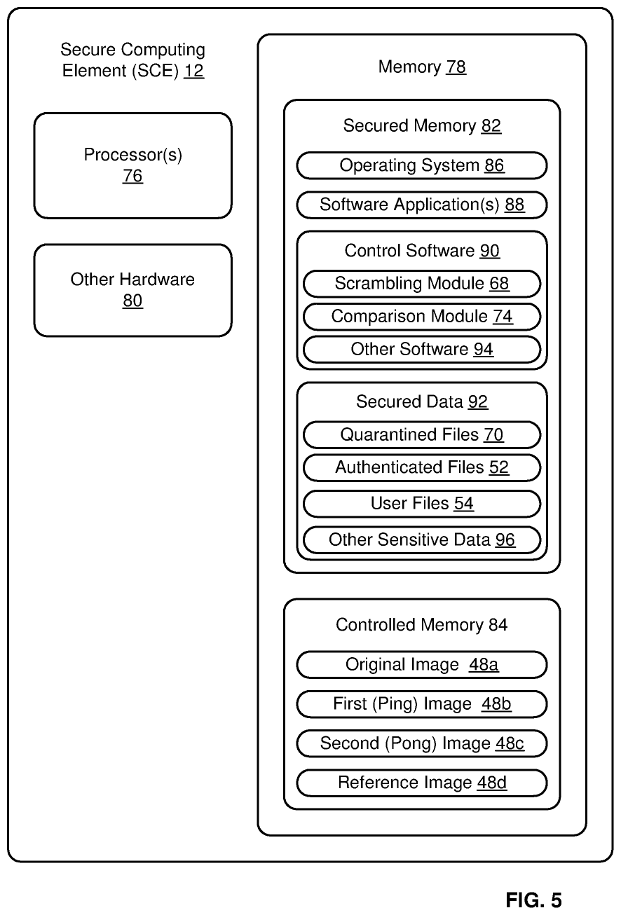

Referring to FIG. 5, in selected embodiments, an SCE 12 in accordance with the present invention may comprise computer hardware and computer software. The computer hardware of an SCE 12 may include one or more processors 79, memory 78 (e.g., one or more memory devices), other hardware 80, or the like or a combination or sub-combination thereof. The memory 78 or selected portions thereof may be operably connected to the one or more processors 76 and store one or more portions of the computer software. This may enable the one or more processors 76 to execute the computer software.

In selected embodiments, the memory 78 of an SCE 12 may be divided into secured memory 82 and controlled memory 84. Controlled memory 84 may be used primarily to store software that is run on a PCE 14, user files that are created on a PCE 14, and the like. Accordingly, in certain embodiments, controlled memory 84 may store an original system image 84a, a first clean system image 48b, a second clean system image 48c, a reference system image 48d, or the like or a combination or sub-combination thereof.

In contrast, secured memory 82 may be memory used primarily to store software that is run on an SCE 12, user files that are created on an SCE 12, and the like. Such software, files, and the like may have any suitable configuration. In certain embodiments, the software of an SCE 12 may include one or more operating systems 86, one or more software applications 88, control software 90, secured data 92, or the like or a combination or sub-combination thereof.

An operating system 86 may manage hardware and software resources in order to provide common services for various computer programs. In selected embodiments, an operating system 86 may manage hardware and software resources in order to provide an environment in which one or more software applications 88 and certain control software 90 may operate.

A software application 88 may be software designed to perform certain functions for the benefit of a user. A software application 88 may enable a user to conduct certain work or activities on an SCE 12. For example, one or more software applications 88 corresponding to an SCE 12 may be programmed to perform or facilitate word processing, database management, downloading of new software, document encryption, or the like.

Control software 90 may be software specifically adapted and used to support the operation of a system 10 in accordance with the present invention. Accordingly, control software 90 may include a scrambling module 68, a comparison module 74, one or more other software modules 94 as desired or necessary, or the like or a combination or sub-combination thereof.

Secured data 92 may be data that requires, was created within, or the like the secure environment provided by an SCE 12. Accordingly, secured data may include one or more quarantined files 70, one or more authenticated files 52, one or more user files 54 (e.g., an encrypted document), other sensitive data (e.g., password information, banking information, etc.), or the like or a combination or sub-combination thereof.

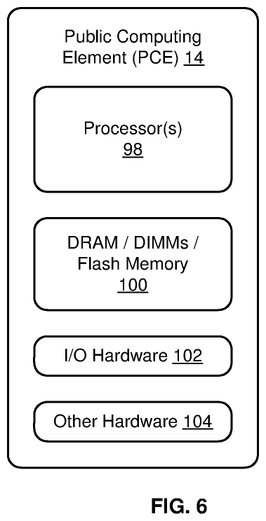

Referring to FIG. 6, in selected embodiments, a PCE 14 in accordance with the present invention may comprise computer hardware and computer software. The computer hardware of a PCE 14 may include one or more processors 98, memory 100, certain I/O hardware 102, other hardware 104, or the like or a combination or sub-combination thereof. The memory 100 or selected portions thereof may be operably connected to the one or more processors 98 and store one or more portions of the computer software. This may enable the one or more processors 98 to execute the computer software.

In selected embodiments, the memory 100 of a PCE 14 may be embodied as DRAM, DIMMs, Flash memory, or the like. Accordingly, the memory 100 may not be or may not include a “boot device.” In such embodiments, controlled memory 84 forming part of an SCE 12 may be a boot device for a PCE 14 and a particular image 48 stored on the controlled memory 84 may be the software stored on the boot device. Thus, in a boot (or reboot) process of a PCE 14, an image 48 or selected portions thereof may be loaded into memory 100 and run by one or more processors 98.

In certain embodiments, one or more input or output devices 20, 36 may be selectively switched from an SCE 12 to a PCE 14 or vice versa. Alternatively, or in addition thereto, certain input/output devices 102 may be permanently fixed to one of an SCE 12 and a PCE 14. Accordingly, in selected embodiments, certain input/output devices 102 may exclusively form part of a PCE 14. For example, for security reasons, one or more designated USB ports supported by a chassis 18 of a system 10 may be an input/output device 102 that exclusively forms part of a PCE 14.

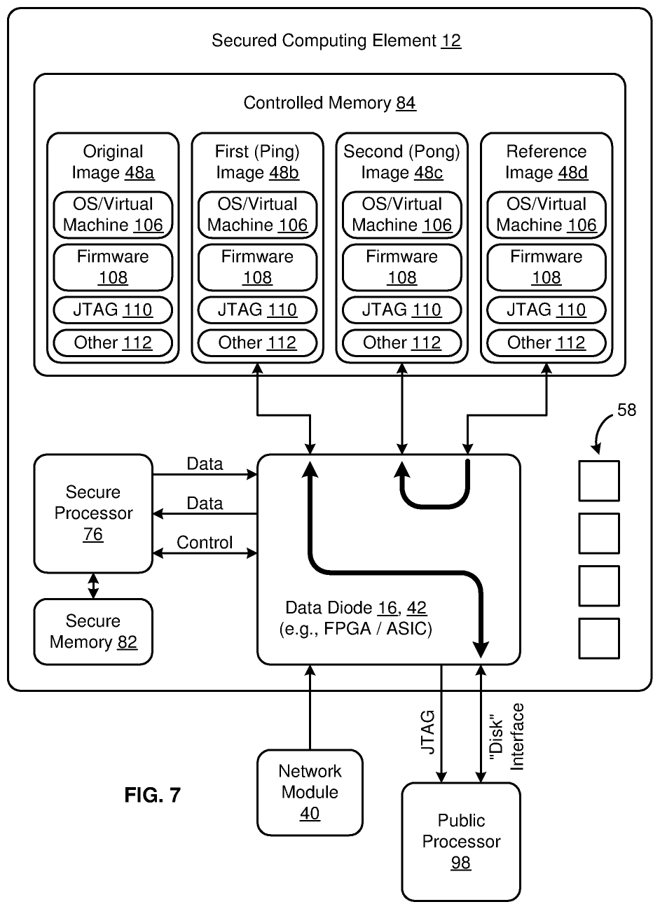

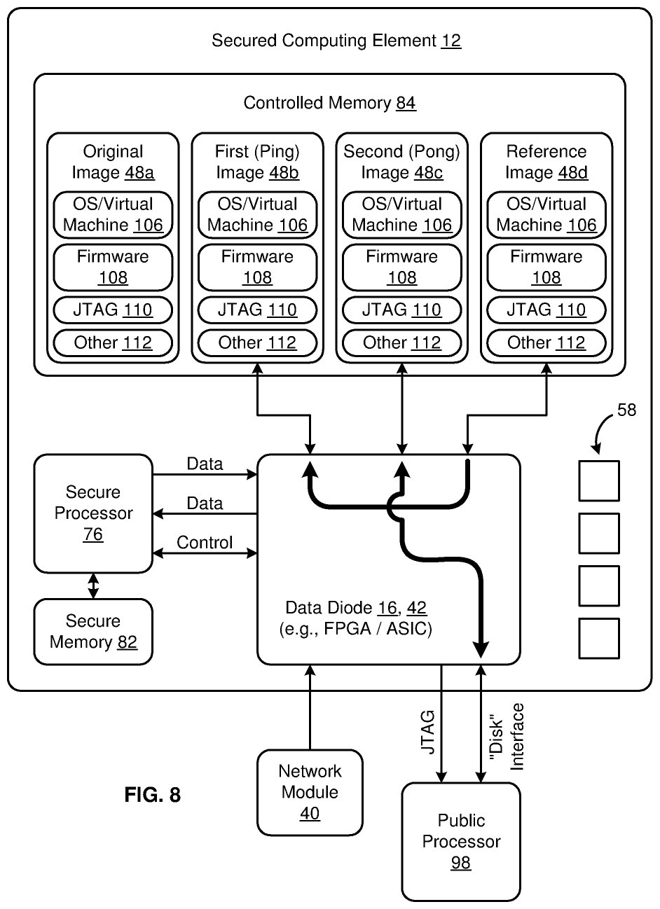

Referring to FIGS. 7 and 8, in certain embodiments, a system image 48 (e.g., an original system image 48a, a first clean “ping” system image 48b, a second clean “pong” system image 48c, and/or a reference system image 48d) may include a primary component 106, BIOS/firmware 108, JTAG information 110, other software or data 112, or the like or a combination or sub-combination thereof. A primary component 106 may be or be configured as an operating system in sleep mode, a virtual machine image and underlying operating system, a custom virtual machine image, or the like. BIOS/Firmware 108 may be manufacturing firmware so as to enable the firmware on a PCE 14 to be written over. This may ensure that no malware is embedded in the firmware. JTAG information 110 may be a file that contains reference information that will enable an SCE 12 to verify whether a particular chip on a PCE 14 is in manufacturing power on state.

In selected embodiments, an FPGA, ASIC, or the like may form one or more data diodes 16, 42 or other connections that connect an SCE 12 to a PCE 14, a public processor 98 to controlled memory 84, a network module 40 to an SCE 12, or the like or a combination or sub-combination thereof. In such embodiments, a secure processor 76 may send data to the FPGA/ASIC, receive data from the FPGA/ASIC, execute control commands with respect to the FPGA/ASIC, or the like or a combination or sub-combination thereof. Data passed from an FPGA/ASIC to a secure processor 76 may include information identifying which system image 48 is currently selected. Control commands may read values out of selected registers of an FPGA/ASIC, write values to selected registers of an FPGA/ASIC, or otherwise control the functionality of an FPGA/ASIC.

In FIG. 7, a “disk” interface of a public processor 98 is connected via an FPGA/ASIC to a “ping” image 48b. A “pong” image 48c is not being used. Accordingly, should the pong image 48c need to be cleaned (i.e., returned to a clean starting condition), a reference system image 48d may be used to overwrite the pong image 48c.

In FIG. 8, a “disk” interface of a public processor 98 is connected via an FPGA/ASIC to a pong image 48c. A ping image 48b is not being used. Accordingly, should the ping image 48b need to be cleaned (i.e., returned to a clean starting condition), a reference system image 48d may be used to overwrite the ping image 48b.

In the above disclosure, reference has been made to the accompanying drawings, which form a part hereof, and in which is shown by way of illustration specific implementations in which the disclosure may be practiced. It is understood that other implementations may be utilized and structural changes may be made without departing from the scope of the present disclosure. References in the specification to “some embodiments,” “other embodiments,” “selected embodiments,” “certain embodiments,” and the like, indicate that the embodiment or embodiments described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment and it is technically feasible, it is submitted that it is within the knowledge of one skilled in the art to affect such feature, structure, or characteristic in connection with other embodiments whether or not explicitly described.

The present invention may be embodied in other specific forms without departing from its spirit or essential characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

What is claimed is:

1. A system comprising:
a secure computing element;
the secure computing element comprising memory storing a first system image and a second system image;
a public computing element locally connected to the secure computing element;
a human input device comprising hardware; and
the human input device configured such that selected actuations thereof transition the public computing element from running the first system image to running the second system image.

2. The system of claim 1, further comprising:
a human output device; and
a switched data diode element selectively connecting the human input device and the human output device to one of the secure computing element and the public computing element.

3. The system of claim 1, further comprising one or more data diodes connecting the secure computing element to the public computing element.

4. The system of claim 1, wherein the first system image comprises operating system files, application files, and one or more user files created by a human user of the system.

5. The system of claim 4, wherein the second system image comprises a clean install of the operating system files and a clean install of the application files.

6. The system of claim 5, wherein the second system image comprises no user files.

7. The system of claim 5, wherein the memory of the secure computing element further stores a third system image.

8. The system of claim 7, wherein the third system image is a reference system image suitable for resetting the second system image.

9. The system of claim 8, wherein the secure processing element uses the third system image to return the second system image to the clean install of the operating system files and the clean install of the application files after the public computing element transitions from running the second system image to running the first system image.

10. The system of claim 9, wherein the memory of the secure computing element further stores a fourth system image.

11. The system of claim 10, wherein:
the fourth system image comprises a clean install of the operating system files and a clean install of the application files; and
the fourth system image comprises no user files.

12. The system of claim 11, wherein the human input device is configured such that selected actuations thereof transition the public computing element from running the first system image to running the fourth system image.

13. The system of claim 12, wherein:
one actuation of the human input device causes the public computing element to run the second system image; and
a next actuation of the human input device causes the public computing element to run the fourth system image.

14. The system of claim 13, wherein the secure processing element uses the third system image to return the fourth system image to the clean install of the operating system files and the clean install of the application files after the public computing element transitions from running the fourth system image to running the first system image.

15. A system comprising:
a computer chassis;
a secure computing element fixed within the computer chassis;
the secure computing element comprising memory storing first, second, third, and fourth system images;
a public computing element fixed within the computer chassis;
a first human input device comprising first hardware fixed with respect to the computer chassis;
the first human input device configured such that actuation thereof transitions the public computing element from running the first system image to running one of the second and third system images;
a second human input device comprising second hardware fixed with respect to the computer chassis; and
the second human input device configured such that actuation thereof transitions the public computing element from running one of the second and third system images to running the first system image.

16. The system of claim 15, further comprising one or more data diodes connecting the secure computing element to the public computing element.

17. The system of claim 16, wherein the first system image comprises operating system files, application files, and one or more user files.

18. The system of claim 17, wherein:
the second and third system images each comprise a clean install of the operating system files and a clean install of the application files; and
neither the second system image nor the third system image comprises user files.

19. The system of claim 18, wherein
the fourth system image is a reference system image suitable for resetting the second and third system images;
the secure processing element uses the fourth system image to return the second system image to a clean install after an actuation of the second human input device transitions the public computing element from running the second system image to running the first system image; and
the secure processing element uses the fourth system image to return the third system image to a clean install after an actuation of the second human input device transitions the public computing element from running the third system image to running the first system image.

20. A method comprising:
obtaining a computing system comprising
a computer chassis,
a secure computing element fixed within the computer chassis,
the secure computing element comprising (1) memory storing first and second system images and (2) a human input device comprising hardware fixed with respect to the computer chassis, and
a public computing element fixed within the computer chassis;
actuating the human input device;
transitioning, by the secure computing element in response to the actuating, the public computing element from running the first system image to running the second system image.
